(19) United States
(12) Patent Application Publication
(10) Pub. No.: US 2026/0189712 A1
(43) Pub. Date: Jul. 2, 2026

(54) DC Only Transform Coefficient Mode For Image And Video Coding

(71) Applicant: GOOGLE LLC, Mountain View, CA (US)

(72) Inventors: Cheng Chen, Milpitas, CA (US); Bohan Li, Santa Clara, CA (US); Debargha Mukherjee, Cupertino, CA (US); Jingning Han, Santa Clara, CA (US); Yaowu Xu, Saratoga, CA (US)

(21) Appl. No.: 19/129,392

(22) PCT Filed: Dec. 19, 2022
(86) PCT No.: PCT/US2022/053382

§ 371 Date: May 13, 2025

Related U.S. Application Data
(60) Provisional application No. 63/425,538, filed on Nov. 15, 2022.

(51) Int. Cl. H04N 19/157; H04N 19/13; H04N 19/176; H04N 19/18; H04N 19/50; H04N 19/61

(52) U.S. Cl. CPC H04N 19/157; H04N 19/13; H04N 19/176; H04N 19/18; H04N 19/50; H04N 19/61

(57) ABSTRACT

A DC only transform coefficient mode is described. A decoder can receive an encoded bitstream including an encoded transform block corresponding to a block and determine, from the encoded bitstream, whether the encoded transform block was encoded using a DC only transform coefficient mode. Responsive to a determination that the encoded transform block was encoded using the DC only transform coefficient mode, only a DC transform coefficient of the encoded transform block from the encoded bitstream is decoded to reconstruct the block. Any other block positions are filled with a zero value.

### BACKGROUND

Digital video streams may represent video using a sequence of frames or still images. Digital video can be used for various applications including, for example, video conferencing, high-definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including compression and other encoding techniques.

### SUMMARY

Disclosed herein are aspects, features, elements, and implementations for encoding and decoding blocks in image and video coding using a DC only transform coefficient mode.

An aspect of the teachings herein includes an apparatus for decoding a block. The apparatus includes a processor configured to receive an encoded bitstream including an encoded block corresponding to the block, determine whether the encoded block was encoded using a DC only transform coefficient mode, and responsive to a determination that the encoded block was encoded using the DC only transform coefficient mode, decode only a DC transform coefficient of the encoded block to reconstruct the block.

In some implementations, to determine whether the encoded transform block was encoded using the DC only transform coefficient mode includes to entropy decode a symbol from the encoded bitstream. In an example of these implementations, the symbol is equal to 1 when all transform coefficients of the block are equal to zero except for the DC transform coefficient, and the symbol is equal to zero when any of the transform coefficients other than the DC transform coefficient has a non-zero value.

In some implementations, to determine whether the encoded transform block was encoded using the DC only transform coefficient mode includes to entropy decode a symbol from the encoded bitstream using context-adaptive binary arithmetic coding (CABAC). To entropy decode the symbol using CABAC may include to entropy decode the symbol using a context derived from at least one transform block neighboring the block.

To entropy decode the symbol using CABAC may include to entropy decode the symbol using a context represented by three bits. In some implementations of this example, the context is represented by a least significant bit that represents a transform block to a left of the block, if present, a second least significant bit that represents a transform block above the block, if present, and a most significant bit that represents a transform block to a top and left of the block, if present. In some implementations of this example, a default value may be used for a bit when a neighboring block is not present. In some implementations of this example, the block is a residual of a prediction block and a value of each bit of the three bits depends on whether the transform block is present and, when present, whether the transform block belongs to the prediction block and whether only a DC coefficient of the transform block has a non-zero value.

In some implementations, the processor can decode, from the encoded bitstream, a zero-coefficient symbol indicating whether the block includes transform coefficients only having zero values. To determine whether the encoded block was encoded using the DC only transform coefficient mode may be responsive to the zero-coefficient symbol indicating that the block includes at least one transform coefficient having a non-zero value.

An aspect of the teachings herein includes a method for decoding a block. The method includes receiving an encoded bitstream including an encoded block corresponding to the block, determining that the encoded block was encoded using a DC only transform coefficient mode, and decoding only a DC transform coefficient of the encoded block to reconstruct the block.

In some implementations, the method includes reconstructing the block by setting the transform coefficients of the block except for the DC transform coefficient to zero.

In some implementations, determining that the encoded block was encoded using the DC only transform coefficient mode includes decoding a symbol from the encoded bitstream identifying that the DC only transform coefficient mode was used to encode the encoded block.

In some implementations the transform coefficients are quantized transform coefficients.

An aspect of the teachings herein includes an apparatus for encoding a block. The apparatus includes a processor configured to determine whether, of transform coefficients of the block, only the DC transform coefficient has a non-zero value, encode a symbol identifying whether a DC only transform coefficient mode is used, a value of the symbol responsive to a determination of whether only the DC transform coefficient has the non-zero value, and encode the block according to the determination.

In some implementations, to encode the block according to the determination includes to entropy encode only the DC transform coefficient of the transform coefficients of the block into the encoded bitstream.

In some implementations the symbol is equal to 1 when all transform coefficients of the block are equal to zero except for the DC transform coefficient, and the symbol is equal to zero when any of the transform coefficients other than the DC transform coefficient has a non-zero value.

In some implementations, to encode the symbol includes to entropy encode the symbol using context-adaptive binary arithmetic coding (CABAC). To entropy encode the symbol using CABAC may include to entropy encode the symbol using a context derived from at least one transform block neighboring the block. To entropy encode the symbol using CABAC may include to derive three bits representing the context from at least one transform block neighboring the block and to entropy encode the symbol using a combination of the three bits.

In some implementations, the three bits include a least significant bit that represents a transform block to a left of the block, if present, a second least significant bit that represents a transform block above the block, if present, and a most significant bit that represents a transform block to a top and left of the block, if present.

In some implementations, the block includes a first transform block that belongs to a prediction block. A value of a bit of the three bits for a position of a neighboring transform block includes 0, when the neighboring transform block is not present at the position, 1, when the neighboring transform block is present, belongs to the prediction block, and only its DC coefficient has a non-zero value, and 0, when the neighboring transform block is present and at least one of the neighboring transform block does not belong to the prediction block or more than one of transform coefficients of the neighboring transform block has a non-zero value.

In some implementations, the processor is configured to determine whether the block includes transform coefficients only having zero values and encode a zero-coefficient symbol indicating whether the block includes at least one transform coefficient having a non-zero value. To determine whether only the DC transform coefficient has the non-zero value and to encode the symbol may only occur responsive to a determination that the block includes at least one transform coefficient having a non-zero value.

An aspect of the teachings herein includes a method for encoding a block. The method includes determining whether, of transform coefficients of the block, only the DC transform coefficient has a non-zero value, encode a symbol identifying whether a DC only transform coefficient mode is used, a value of the symbol responsive to a determination of whether only the DC transform coefficient has the non-zero value, and encode the block according to the determination.

An aspect of the teachings herein includes a method for encoding a block. The method includes determining that, of transform coefficients of the block, only the DC transform coefficient has a non-zero value and encode a block according to a DC only transform coefficient mode comprising to encode only the DC transform coefficient of the block and omit an end-of-block identifier.

These and other aspects of the present disclosure are disclosed in the following detailed description of the embodiments, the appended claims, and the accompanying figures.

### BRIEF DESCRIPTION OF THE DRAWINGS

The description herein makes reference to the accompanying drawings described below, wherein like reference numerals refer to like parts throughout the several views.

FIG. 1 is a schematic of a video encoding and decoding system.

FIG. 2 is a block diagram of an example of a computing device that can implement a transmitting station or a receiving station.

FIG. 3 is a diagram of a video stream to be encoded and subsequently decoded.

FIG. 4 is a block diagram of an encoder according to implementations of this disclosure.

FIG. 5 is a block diagram of a decoder according to implementations of this disclosure.

FIG. 6 is a flowchart diagram of a technique for encoding a block using a DC only transform coefficient mode according to implementations of this disclosure.

FIG. 7A is a block including transform coefficients used to explain the technique of FIG. 6, and FIG. 7B is a block including quantized transform coefficients used to explain the technique of FIG. 6.

FIG. 8 is a flowchart diagram of a technique for decoding a block using a DC only transform coefficient mode according to implementations of this disclosure.

### DETAILED DESCRIPTION

Compression schemes related to coding images and video streams may include breaking images into blocks and generating a digital video output bitstream (i.e., an encoded bitstream) using one or more techniques to limit the information included in the output bitstream. A received bitstream can be decoded to re-create (reconstruct, reproduce, etc.) the blocks and the source images from the limited information.

Encoding image data (whether the source in a single image or a frame of a video stream), or a portion thereof, such as a block, can include exploiting spatial and, where applicable, temporal similarities to improve coding efficiency. For example, a current block of a video stream may be encoded based on identifying a difference (residual) between previously coded pixel values, or between a combination of previously coded pixel values, and those in the current block. The difference represents a smaller amount of data to encode and subsequently decode.

The amount of data may be further reduced by converting the values of the residual to the frequency domain, e.g., using a sinusoidal transform such as a Discrete Cosine Transform (DCT). The resulting transform coefficients undergo transform coefficient coding. Transform coefficient coding defines the coding order of coefficients, the use of contexts, discussed in more detail below, and how each coefficient is coded. Using transform coefficient coding, raw transform coefficients are losslessly converted into binary representations (e.g., using entropy coding) and are written into a bitstream for subsequent reconstruction. The algorithm of coding the transform coefficients has a substantial impact on compression efficiency.

The energy of a block after transformation using a sinusoidal transform is concentrated in the Direct Current (DC) coefficient. This disclosure describes a DC only transform coefficient mode that checks if only the DC coefficient is non-zero among all transform coefficients in a block and signals this information in the bitstream. Using the mode can increase compression efficiency in transform coding by eliminating the need to include other values associated with coding a block. For example, signaling an end-of-block (EOB) indicator may be avoided for a block encoded using the DC only transform coefficient mode.

Further details of the DC only transform coefficient signaling mode for image and video coding are described herein with initial reference to a system or apparatus in which the mode can be implemented.

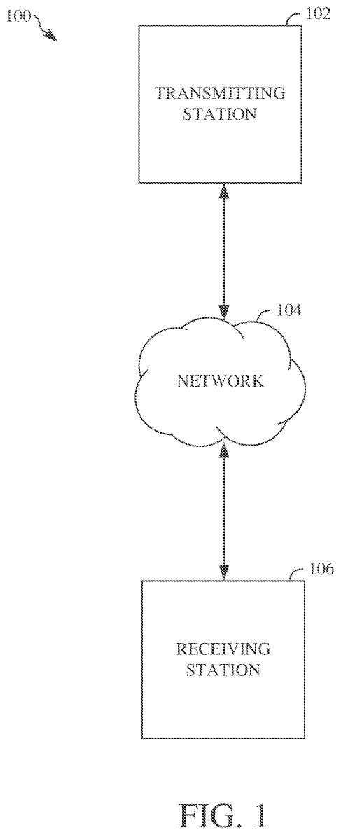

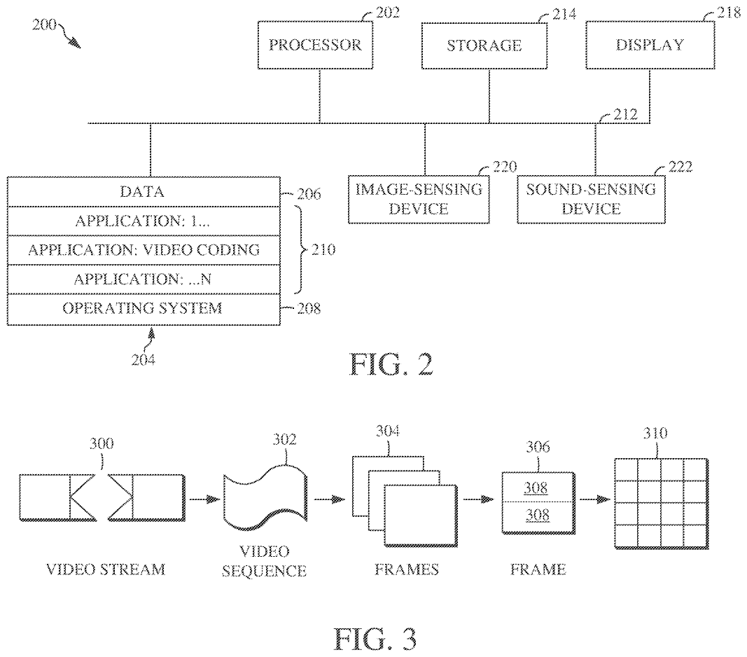

FIG. 1 is a schematic of a video encoding and decoding system 100. A transmitting station 102 can be, for example, a computer having an internal configuration of hardware such as that described in FIG. 2. However, other suitable implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102, and the encoded video stream can be decoded in the receiving station 106. The network 104 can be, for example, the Internet. The network 104 can also be a local area network (LAN), wide area network (WAN), virtual private network (VPN), cellular telephone network, or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used, e.g., a Hypertext Transfer Protocol (HTTP) video streaming protocol.

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits his or her own video bitstream to the video conference server for decoding and viewing by other participants.

FIG. 2 is a block diagram of an example of a computing device 200 that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A CPU 202 in the computing device 200 can be a conventional central processing unit. Alternatively, the CPU 202 can be any other type of device, or multiple devices, capable of manipulating or processing information now existing or hereafter developed. Although the disclosed implementations can be practiced with one processor as shown (e.g., the CPU 202), advantages in speed and efficiency can be achieved by using more than one processor.

A memory 204 in computing device 200 can be a read only memory (ROM) device or a random-access memory (RAM) device in an implementation. Any other suitable type of storage device can be used as the memory 204. The memory 204 can include code and data 206 that is accessed by the CPU 202 using a bus 212. The memory 204 can further include an operating system 208 and application programs 210, the application programs 210 including at least one program that permits the CPU 202 to perform the methods described herein. For example, the application programs 210 can include applications 1 through N, which further include a video coding application that performs the techniques described here, such as the techniques for performing inter-prediction of a current block with filtering. Computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the CPU 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display, or a light emitting diode (LED) display, such as an organic LED (OLED) display.

The computing device 200 can also include or be in communication with an image-sensing device 220, for example, a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example, a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the CPU 202 and the memory 204 of the computing device 200 as being integrated into a single unit, other configurations can be utilized. The operations of the CPU 202 can be distributed across multiple machines (wherein individual machines can have one or more processors) that can be coupled directly or across a local area or other network. The memory 204 can be distributed across multiple machines such as a network-based memory or memory in multiple machines performing the operations of the computing device 200. Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

FIG. 3 is a diagram of an example of a video stream 300 to be encoded and subsequently decoded. The video stream 300 includes a video sequence 302. At the next level, the video sequence 302 includes a number of adjacent frames 304. While three frames are depicted as the adjacent frames 304, the video sequence 302 can include any number of adjacent frames 304. The adjacent frames 304 can then be further subdivided into individual frames, for example, a frame 306. At the next level, the frame 306 can be divided into a series of planes or segments 308. The segments 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, 16×16 pixels in the frame 306. The blocks 310 can also be arranged to include data from one or more segments 308 of pixel data. The blocks 310 can also be of any other suitable size such as 4×4 pixels, 8×8 pixels, 16×8 pixels, 8×16 pixels, 16×16 pixels, or larger. Unless otherwise noted, the terms block and macroblock are used interchangeably herein.

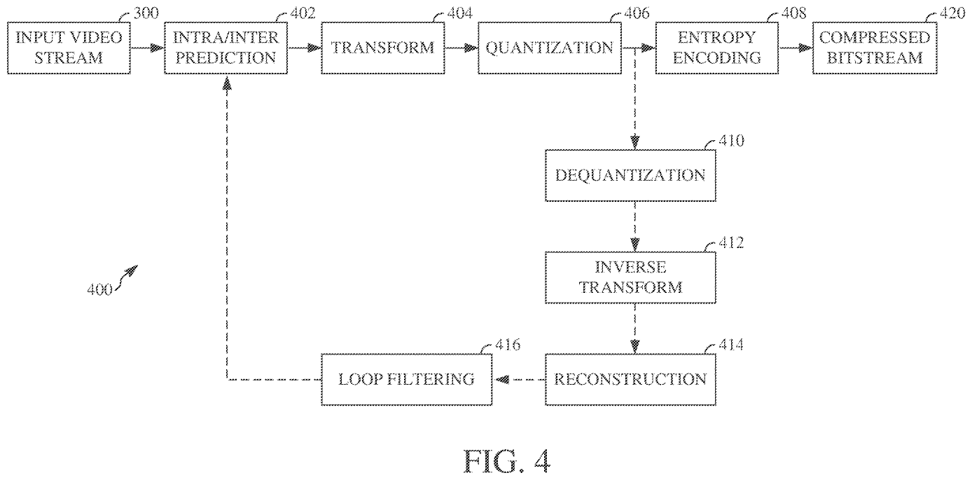

FIG. 4 is a block diagram of an encoder 400 according to implementations of this disclosure. The encoder 400 can be implemented, as described above, in the transmitting station 102, such as by providing a computer software program stored in memory, for example, the memory 204. The computer software program can include machine instructions that, when executed by a processor such as the CPU 202, cause the transmitting station 102 to encode video data in the manner described in FIG. 4. The encoder 400 can also be implemented as specialized hardware included in, for example, the transmitting station 102. In one particularly desirable implementation, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

When the video stream 300 is presented for encoding, respective adjacent frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames.

Next, still referring to FIG. 4, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated. The quantized transform coefficients are then entropy encoded by the entropy encoding stage 408. The entropy-encoded coefficients, together with other information used to decode the block (which may include, for example, the type of prediction used, transform type, motion vectors and quantizer value), are then output to the compressed bitstream 420. The compressed bitstream 420 can be formatted using various techniques, such as variable length coding (VLC) or arithmetic coding. The compressed bitstream 420 can also be referred to as an encoded video stream or encoded video bitstream, and the terms will be used interchangeably herein.

The reconstruction path in FIG. 4 (shown by the dotted connection lines) can be used to ensure that the encoder 400 and a decoder 500 (described below) use the same reference frames to decode the compressed bitstream 420. The reconstruction path performs functions that are similar to functions that take place during the decoding process (described below), including dequantizing the quantized transform coefficients at the dequantization stage 410 and inverse transforming the dequantized transform coefficients at the inverse transform stage 412 to produce a derivative residual block (also called a derivative residual). At the reconstruction stage 414, the prediction block that was predicted at the intra/inter prediction stage 402 can be added to the derivative residual to create a reconstructed block. The loop filtering stage 416 can be applied to the reconstructed block to reduce distortion such as blocking artifacts.

Other variations of the encoder 400 can be used to encode the compressed bitstream 420. For example, a non-transform-based encoder can quantize the residual signal directly without the transform stage 404 for certain blocks or frames. In another implementation, an encoder can have the quantization stage 406 and the dequantization stage 410 combined in a common stage.

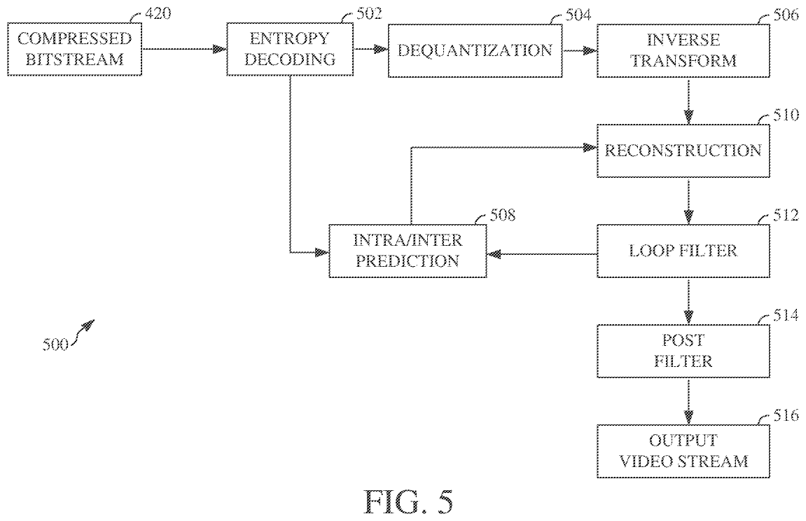

FIG. 5 is a block diagram of a decoder 500 according to implementations of this disclosure. The decoder 500 can be implemented in the receiving station 106, for example, by providing a computer software program stored in the memory 204. The computer software program can include machine instructions that, when executed by a processor such as the CPU 202, cause the receiving station 106 to decode video data in the manner described in FIG. 5. The decoder 500 can also be implemented in hardware included in, for example, the transmitting station 102 or the receiving station 106.

Like the reconstruction path of the encoder 400 discussed above, the decoder 500 includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512, and a post filtering stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400, e.g., at the intra/inter prediction stage 402. At the reconstruction stage 510, the prediction block can be added to the derivative residual to create a reconstructed block. The loop filtering stage 512 can be applied to the reconstructed block to reduce blocking artifacts.

Other filtering can be applied to the reconstructed block. In this example, the post filtering stage 514 is applied to the reconstructed block to reduce blocking distortion or perform other post-processing on a frame, and the result is output as the output video stream 516. The output video stream 516 can also be referred to as a decoded video stream, and the terms will be used interchangeably herein. Other variations of the decoder 500 can be used to decode the compressed bitstream 420. For example, the decoder 500 can produce the output video stream 516 without the post filtering stage 514.

As explained above, a codec may use a transform coding scheme where the residue (or residual) of the source and predicted signal is transformed by a sinusoidal transform. The transform reduces the correlation in the original residual signal and condenses information into a few coefficients. The transform coefficients can be quantized and arithmetically coded to achieve the goal of compression.

The DC coefficient of the transform coefficients represents a large percentage of the information of the residual signal. One technique that may improve reconstruction, when quantization is used, is to select a different quantizer value only for the DC coefficient. Whether or not this technique is used, the teachings herein propose using a symbol in the bitstream to signal whether only the DC coefficient has a non-zero value among all (e.g., quantized) transform coefficients in a block. The symbol is entropy coded, which may be conditioned on the symbol values of neighboring blocks.

The context used for the entropy coding is based on a hypothesis that residual signals could have similar patterns and therefore transform coefficients might also have similar distributions in a close neighborhood. Although it is difficult to model correlations of transform coefficients between different blocks, a correlation between neighboring blocks whether only the DC coefficient is non-zero is possible because the residual energy often condenses on the DC coefficient.

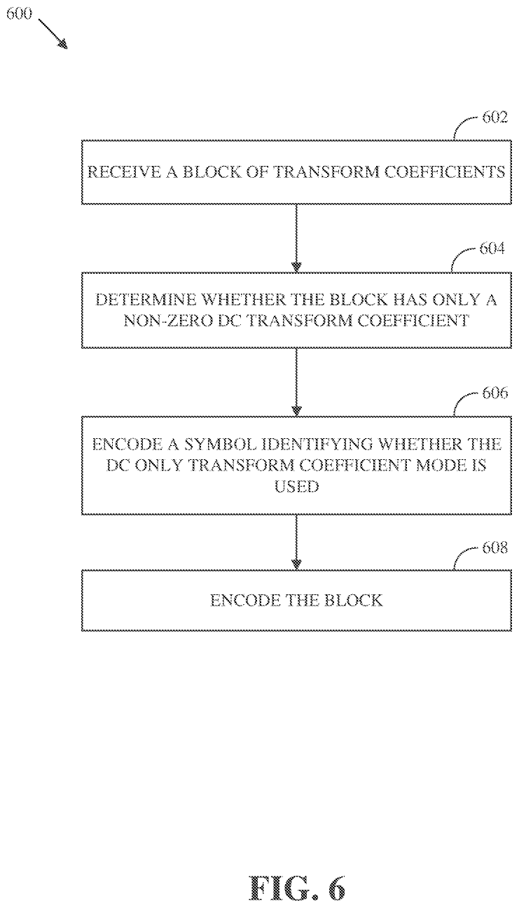

Details of some implementations of this disclosure are next described with regards to FIGS. 6-8.

FIG. 6 is a flowchart diagram of a method or technique 600 for encoding a block using a DC only transform coefficient mode. The technique 600 can be implemented in an encoder such as the encoder 400 of FIG. 4.

The technique 600 can be implemented, for example, as a software program that can be executed by computing devices such as transmitting station 102. The software program can include machine-readable instructions (e.g., executable instructions) that can be stored in a memory such as the memory 204 or the secondary storage 214, and that can be executed by a processor, such as CPU 202, to cause the computing device to perform the technique 600. In at least some implementations, the technique 600 can be performed at least in part by the entropy encoding stage 402 of the encoder 400 of FIG. 4.

The technique 600 can be implemented using specialized hardware or firmware. Some computing devices can have multiple memories, multiple processors, or both. The steps or operations of the technique 600 can be distributed using different processors, memories, or both. Use of the term “processor” or “memory” in the singular here and elsewhere in this disclosure encompasses computing devices that have one processor or one memory as well as devices that have multiple processors or multiple memories that can be used in the performance of some or all of the recited steps.

At 602, a block of transform coefficients is received. The block of transform coefficients may be generated from a block of an image, whether the image is a single image or a frame. The block of the image may be a luminance block (e.g., a Y block) or a chrominance block (e.g., a Cb block, a Cr block, a U block, or a V block). The block of the image may be a block in a plane of another color scheme, such as a red-green-blue color scheme.

The block of transform coefficients may be a residual block generated by inter-prediction or intra-prediction, such as at the intra-inter prediction stage 402, and transformed to the frequency domain, such as at the transform stage 404. Optionally, the block of transform coefficients may be quantized, such as at the quantization stage 406. Whether quantized or not, the block of transform coefficients may be received for entropy coding, such as at the entropy encoding stage 408.

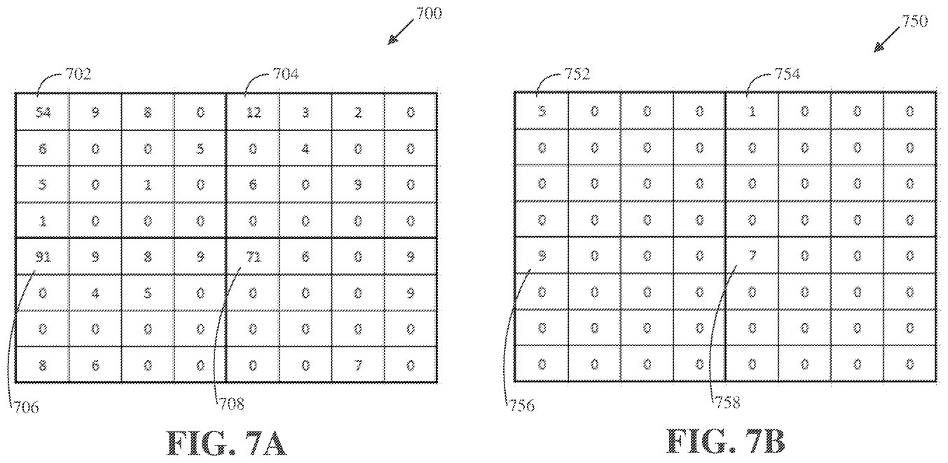

Examples of blocks of transform coefficients are shown FIGS. 7A and 7B. FIG. 7A is a block 700 including transform coefficients used to explain the technique 600 of FIG. 6, and FIG. 7B is a block 750 including quantized transform coefficients used to explain the technique 600 of FIG. 6. The blocks 700 and 750 are generated from a residual of a prediction block as described above with regards to FIG. 4. While the block 700 could comprise a single transform block, e.g., a single block of transform coefficients, in this example the 8×8 residual is transformed using four transforms to generate four 4×4 transform blocks, e.g., four blocks of transform coefficients C. The transform blocks are separated by heavy lines in FIG. 7A. In FIG. 7A, the values of the transform coefficients C are not quantized values, and the DC coefficient 702, 704, 706, 708 of each is labeled.

In FIG. 7B, the transform blocks are each quantized, such as at the quantization stage 406, to produce quantized coefficients QC. The quantizer, or quantization step size, Q is a constant of 10 such that QC=floor(C/Q). However, other quantizers or different quantizers are possible. After quantization, only the DC coefficients 752, 754, 756, 758 are not zero (i.e., have non-zero values).

At 604, the technique 600 determines whether, of the transform coefficients of the block, only the DC transform coefficient has a non-zero value. In the example of FIG. 7B, each of the four transform blocks that belongs to the block 750 has all zero transform coefficients except for the DC transform coefficient. Thereafter, the technique 600 may encode a symbol identifying whether a DC only transform coefficient mode is used at 606. The value of the symbol is responsive to a determination of whether only the DC transform coefficient has the non-zero value. The symbol may comprise a single bit. For example, the symbol may be equal to one when all transform coefficients are equal to zero except for the DC coefficient. The symbol may be equal to zero when at least one transform coefficient other than the DC coefficient has a non-zero value.

A technique for encoding the symbol at 606 may use information from neighboring block(s) to generate a context for context-based entropy coding. The context may be derived from at least one transform block neighboring the block of transform coefficients being coded. In an example, encoding the symbol at 606 may include entropy encoding the symbol using CABAC.

In some implementations, the context may be represented by three bits. A least significant bit may represent a transform block to the left of the block (also referred to as a left transform block), a second least significant bit may represent a transform block above the block (also referred to as an above transform block), and a most significant bit may represent a transform block to the top and left of the block (also referred to as a top-left transform block). The selection of these transform blocks to determine the context is based on a raster scan order for encoding blocks, but other neighboring blocks may be used, e.g., when a different scan order is used.

If (i, j) represents the transform block being encoded, the left transform block is represented by (i-1, j), the above transform block is represented by (i, j-1), and the top-left transform block is represented by (i-1, j-1). The value of each bit of the representation may be determined by a combination of (e.g., depends on) features/information from each block. In some implementations, the value for a bit may be determined based on whether the neighboring transform block belongs to the same prediction block as the transform block being encoded. In some implementations, the value for a bit may be determined based on whether the neighboring transform block uses the DC only transform coefficient mode. Stated differently, the value for the bit may be determined based on whether the transform coefficients of the neighboring block are all zero except for the DC transform coefficient. In some implementations, both the determination of whether the neighboring transform block belongs to the same prediction block as the transform block being encoded and whether the neighboring transform block uses the DC only transform coefficient mode may be used to determine the value of a corresponding bit (i.e., the bit corresponding to the neighboring transform block).

In an example of the latter implementations, the value of a bit may be 1 if both the function is_same_prediction(u, v) and the function is_DC_nz_only(u, v) both return 1, wherein:
a) the function is_same_prediction(u, v) returns 1 if the transform block (u, v) and the current transform block (i, j) belong to the same prediction block, and otherwise returns 0;
b) the function is_DC_nz_only returns 1 if only the DC coefficient is not zero for the transform block (u, v), and otherwise returns 0; and
c) (u, v) is one of (i-1, j), (i, j-1), or (i-1, j-1).

Otherwise, the value of the bit is 0.

The foregoing example describes the bits when each of the neighboring transform blocks is available. That is, the example describes how to determine the value for a corresponding bit when a neighboring transform block is present. If a neighboring transform block is not present, the value of its corresponding bit may be set to a default value such as 0.

An example is next described using FIG. 7B with the assumption that the block 750 is the first block of the image/frame being coded. The transform block associated with DC coefficient 752 would use the DC only transform coefficient mode, and the symbol identifying the mode would be 000 because a left transform block, an above transform block, and a top-left transform block are not present. The transform block associated with DC coefficient 754 would use the DC only transform coefficient mode, and the symbol identifying the mode would be 100 because the left transform block is present, uses the DC only transform coefficient mode, and belongs in the same prediction block 750, an above transform block is not present, and a top-left transform block is not present. The transform block associated with DC coefficient 756 would use the DC only transform coefficient mode, and the symbol identifying the mode would be 010 because a left transform block is not present, the above transform block is not present, uses the DC only transform coefficient mode, and belongs in the same prediction block 750, and a top-left transform block is not present. The transform block associated with DC coefficient 758 would use the DC only transform coefficient mode, and the symbol identifying the mode would be 111 because each of the left transform block, the above transform block, and the top-left transform block is present, uses the DC only transform coefficient mode, and belongs in the same prediction block 750.

In summary and according to the above, the transform blocks may be used to derive the context to entropy code the symbol at 606 according to the following equation.

$$context = ( is\_same \_prediction ( i - 1 , j ) * is\_DC \_nz \_only ( i - 1 , j ) ) + ( is\_same \_prediction ( i , j - 1 ) * is\_DC \_nz \_only ( i , j - 1 ) ) * 2 + ( is\_same \_prediction ( i - 1 , j - 1 ) * is\_DC \_nz \_only ( i - 1 , j - 1 ) ) * 4$$

At 608, the block is encoded. The block may be encoded according to the determination at 604. For example, if the determination is that at least one other transform coefficient has a non-zero value, the block may be encoded according to existing techniques. Namely, transform coefficients are entropy encoded into a compressed bitstream, such as the compressed bitstream 420, according to an encoding order. The entropy coding may comprise any entropy coding technique, whether context-based or not. The entropy coding may comprise Context-Adaptive Binary Arithmetic Coding (CABAC). An end-of-block (EOB) signal may be encoded into the compressed bitstream to indicate the last non-zero transform coefficient of the block of transform coefficients. Any other technique for signaling the position of the last non-zero transform coefficient of the block may be used.

If, at 604, it is determined that, of the transform coefficients of the block, only the DC transform coefficient has a non-zero value, the block may be encoded according to a DC only transform coefficient mode. Namely, only the DC transform coefficient of the block may be encoded into the bitstream while an identifier of the last non-zero transform is omitted. For example, the EOB identifier may be omitted. The DC transform coefficient may be entropy coded according to any entropy coding technique, whether context-based or not. The entropy coding may comprise CABAC.

In some implementations, the symbol (symbol DC_only in an example) indicating whether a DC only transform coefficient mode is used is encoded into the compressed bitstream after a symbol indicating whether all transform coefficients of the block comprise zero values (stated otherwise, that no transform coefficient of the block has a non-zero value, including the DC coefficient). This symbol may be referred to as a zero-coefficient symbol. In such an implementation, the processing of the technique 600 may be skipped in its entirety for a residual because there are no non-zero coefficients to encode. In other words, in some implementations, whether only the DC transform coefficient has the non-zero value and encoding the symbol DC_only only occurs at an encoder responsive to a determination that the block includes at least one transform coefficient having a non-zero value. Further, checking for the symbol DC_only may only occur at the decoder when the zero-coefficient symbol indicates that at least one of the transform coefficients of the current block to be decoded has a non-zero value.

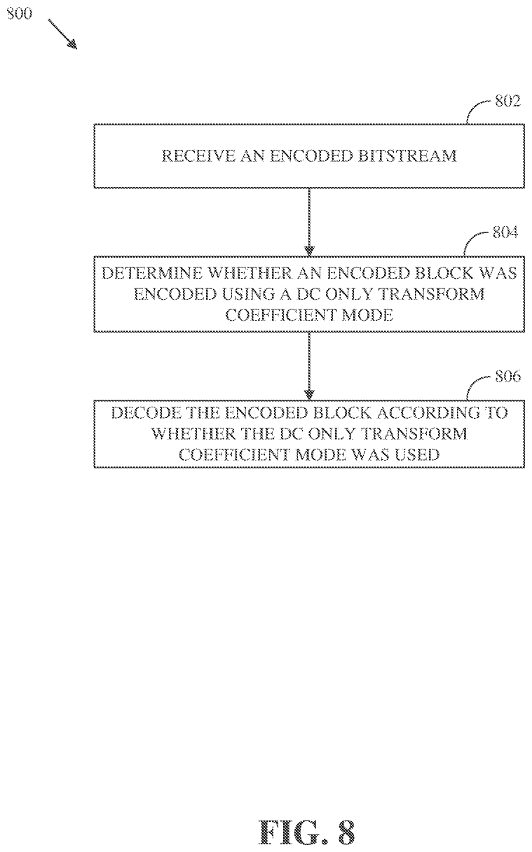

FIG. 8 is a flowchart diagram of a technique 800 for decoding a block using a DC only transform coefficient mode. The technique 800 can be implemented in a decoder such as the decoder 500 of FIG. 5 or in the reconstruction path of FIG. 4. The technique 800 can be implemented, for example, as a software program that can be executed by computing devices such as transmitting station 102 or the receiving station 106 of FIG. 1. The software program can include machine-readable instructions (e.g., executable instructions) that can be stored in a memory such as the memory 204 or the secondary storage 214, and that can be executed by a processor, such as CPU 202, to cause the computing device to perform the technique 800. In some implementations, the technique 800 can be performed at least in part by the entropy decoding stage 502 of the decoder 500 of FIG. 5.

The technique 800 can be implemented using specialized hardware or firmware. Some computing devices can have multiple memories, multiple processors, or both. The steps or operations of the technique 800 can be distributed using different processors, memories, or both.

The technique 800 receives an encoded bitstream, such as the encoded or compressed bitstream 420, at 802. At 804, the technique 800 determines whether an encoded block was encoded using a DC only transform coefficient mode. As explained above, whether the encoded block was encoded using the DC only transform coefficient mode may be indicated by a symbol entropy encoded into the encoded bitstream. Accordingly, determining whether the encoded block was encoded using the DC only transform coefficient mode can include entropy decoding the symbol. If the symbol was entropy encoded using a context determined using information from neighboring transform blocks, if present, the context may be similarly derived and used to entropy decode the symbol. The implementation described above, for example, uses three bits derived from the left transform block, the above transform block, and the top-left transform block to identify the context and uses that context for CABAC.

An example of a modification of syntax for use by a decoder that incorporates the teachings herein is shown below. The code is modified from the current code for the AV1 codec. The new syntax is shaded. In brief, the code checks the value of DC_only. Where the value of DC_only indicates that the only coefficient with a non-zero value is the DC coefficient, the code sets the EOB value to 1 so that the EOB signal is not searched for within the bitstream (e.g., because there is only one transform coefficient coded for the transform block). Thereafter, the transform type is determined based on the data type (luma plane or chroma plane) as is currently done. The transform coefficients (here one transform coefficient) are collected as a vector (scan) in scan order for further processing, and the end of block value is incremented so that the code can determine whether further transform blocks associated with a prediction block are to be processed or whether all transform blocks associated with a prediction block have been retrieved. This code is by example only—other code may be used here and when the invention is implemented in a different codec.

| | Type |
|---|---|
| coeffs( plane, startX, startY, txSz ) { | |
| x4 = startX >> 2 | |
| y4 = startY >> 2 | |
| w4 = Tx_Width[ txSz ] >> 2 | |
| h4 = Tx_Height[ txSz ] >> 2 | |
| . | |
| . | |
| . | |
| eob = 0 | |
| culLevel = 0 | |
| dcCategory = 0 | |
| all_zero | S( ) |
| if ( all_zero ) { | |
| c = 0 | |
| if ( plane == 0 ) { | |
| for ( i = 0; i < w4; i++ ) { | |
| for ( j = 0; j < h4; j++ ) { | |
| TxTypes[ y4 + j ][ x4 + i ] = DCT_DCT | |
| } | |
| } | |
| } | |
| } else { | |
| DC_only | S( ) |
| if (DC_only) { | |
| eob = 1 (because EOB omitted) | |
| if ( plane == 0 ) transform_type( x4, y4, txSz ) | |
| PlaneTxType = compute_tx_type( plane, txSz, x4, y4 ) | |
| scan = get_scan( txSz ) | |
| } else { | |
| if ( plane == 0 ) | |
| transform_type( x4, y4, txSz ) | |
| PlaneTxType = compute_tx_type( plane, txSz, x4, y4 ) | |
| scan = get_scan( txSz ) | |
| eobMultisize = Min( Tx_Width_Log2[ txSz ], 5) + Min( Tx_Height_Log2[ | |
| txSz ], 5) − 4 | |
| if ( cobMultisize == 0 ) { | |
| eob_pt_16 | S( ) |
| eobPt = eob_pt_16 + 1 | |
| . | |
| . | |
| . | |
| } | |
| eob = ( eobPt < 2 ) ? eobPt : ( ( 1 << ( eobPt − 2 ) ) + 1 ) | |
| eob = eob + 1 | |
| eobShift = Max( −1, eobPt − 3 ) | |
| if ( eobShift >= 0 ) { | |
| eob_extra | S( ) |
| if ( eob_extra ) { | |
| eob += ( 1 << eobShift ) | |
| } | |
| for ( i = 1; i < Max( 0, eobPt − 2 ); i++ ) { | |
| eobShift = Max( 0, eobPt − 2) − 1 − i | |
| eob_extra_bit | L(1) |
| if ( eob_extra_bit ) { | |
| eob += ( 1 << eobShift ) | |
| } | |
| } | |
| } | |
| } | |
| for ( c = eob − 1; c >= 0; c−− ) { | |
| pos = scan[ c ] | |
| if ( c == ( eob − 1 ) ) { | |
| coeff_base_eob | S( ) |
| level = coeff_base_eob + 1 | |
| } else { | |
| coeff_base | S( ) |
| level = coeff_base | |
| } | |
| . | |
| . | |
| . | |
| culLevel = Min( 63, culLevel ) | |
| } | |
| . | |
| . | |
| . | |
| return eob | |
| } | |

At 806, the encoded block is decoded according to whether the DC only transform coefficient mode was used. For example, where the DC only transform coefficient mode was used, the encoded block may be decoded by entropy decoding the DC transform coefficient, reconstructing a residual by setting all the remaining transform coefficients to zero and performing an inverse transform of the transform coefficients (with optional dequantization), re-generating the prediction block from information in the encoded bitstream, and reconstructing the block by adding the prediction block to the residual.

For simplicity of explanation, techniques herein are depicted and described as respective series of steps or operations. However, the steps or operations in accordance with this disclosure can occur in various orders and/or concurrently. Additionally, other steps or operations not presented and described herein may be used. Furthermore, not all illustrated steps or operations may be required to implement a method in accordance with the disclosed subject matter.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as being preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise or clearly indicated otherwise by the context, the statement “X includes A or B” is intended to mean any of the natural inclusive permutations thereof. That is, if X includes A; X includes B; or X includes both A and B, then “X includes A or B” is satisfied under any of the foregoing instances. In addition, the articles “a” and “an” as used in this application and the appended claims should generally be construed to mean “one or more,” unless specified otherwise or clearly indicated by the context to be directed to a singular form. Moreover, use of the term “an implementation” or the term “one implementation” throughout this disclosure is not intended to mean the same embodiment or implementation unless described as such.

Implementations of the transmitting station 102 and/or the receiving station 106 (and the algorithms, methods, instructions, etc., stored thereon and/or executed thereby, including by the encoder 400 and the decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server, and the receiving station 106 can be implemented on a device separate from the server, such as a handheld communications device. In this instance, the transmitting station 102, using an encoder 400, can encode content into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device, and/or a device including an encoder 400 may also include a decoder 500.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or semiconductor device. Other suitable mediums are also available.

The above-described embodiments, implementations, and aspects have been described to facilitate easy understanding of this disclosure and do not limit this disclosure. On the contrary, this disclosure is intended to cover various modifications and equivalent arrangements included within the scope of the appended claims, which scope is to be accorded the broadest interpretation as is permitted under the law to encompass all such modifications and equivalent arrangements.

1. An apparatus for decoding a block, comprising:
a processor configured to:
receive an encoded bitstream including an encoded transform block corresponding to the block;
determine, from the encoded bitstream, whether the encoded transform block was encoded using a DC only transform coefficient mode; and
responsive to a determination that the encoded transform block was encoded using the DC only transform coefficient mode, decode only a DC transform coefficient of the encoded transform block from the encoded bitstream to reconstruct the block.

2. The apparatus of claim 1, wherein to determine whether the encoded transform block was encoded using the DC only transform coefficient mode comprises to:
entropy decode a symbol from the encoded bitstream.

3. The apparatus of claim 2, wherein the symbol is equal to 1 when all transform coefficients of the block are equal to zero except for the DC transform coefficient, and the symbol is equal to zero when any of the transform coefficients other than the DC transform coefficient has a non-zero value.

4. The apparatus of claim 1, wherein to determine whether the encoded transform block was encoded using the DC only transform coefficient mode comprises to:
entropy decode a symbol from the encoded bitstream using context-adaptive binary arithmetic coding (CABAC) with a context derived from at least one transform block neighboring the block.

5. The apparatus of claim 4, wherein the context is represented by three bits including:
a least significant bit that represents a transform block to a left of the block, if present, a second least significant bit that represents a transform block above the block, if present, and a most significant bit that represents a transform block to a top and left of the block, if present.

6. The apparatus of claim 4, wherein the block is a residual of a prediction block, the context is represented by three bits, and a value of each bit of the three bits depends on whether the transform block is present and, when present, whether the transform block belongs to the prediction block and whether only a DC coefficient of the transform block has a non-zero value.

7. The apparatus of claim 1, wherein the processor is configured to:
decode, from the encoded bitstream, a zero-coefficient symbol indicating whether the block includes transform coefficients only having zero values; and
determine whether the encoded block was encoded using the DC only transform coefficient mode responsive to the zero-coefficient symbol indicating that the block includes at least one transform coefficient having a non-zero value.

8. A method for decoding a block, comprising:
receiving an encoded bitstream including an encoded block corresponding to the block;
determining, from the encoded bitstream, that the encoded block was encoded using a DC only transform coefficient mode; and
responsive to the determining, decoding only a DC transform coefficient of the encoded block from the encoded bitstream to reconstruct the block.

9. The method of claim 8, wherein determining that the encoded block was encoded using the DC only transform coefficient mode comprises:
decoding a symbol from the encoded bitstream identifying that the DC only transform coefficient mode was used to encode the encoded block.

10. An apparatus for encoding a block, comprising:
a processor configured to:
determine whether, of transform coefficients of the block, only a DC transform coefficient has a non-zero value;
encode, into an encoded bitstream, a symbol identifying whether a DC only transform coefficient mode is used, a value of the symbol responsive to a determination of whether only the DC transform coefficient has the non-zero value; and
encode the block into the encoded bitstream according to the determination.

11. The apparatus of claim 10, wherein to encode the block according to the determination comprises to:
entropy encode only the DC transform coefficient of the transform coefficients of the block into the encoded bitstream.

12. The apparatus of claim 10, wherein the symbol is equal to 1 when all transform coefficients of the block are equal to zero except for the DC transform coefficient, and the symbol is equal to zero when any of the transform coefficients other than the DC transform coefficient has a non-zero value.

13. The apparatus of claim 10, wherein to encode the symbol comprises to entropy encode the symbol using context-adaptive binary arithmetic coding (CABAC) and a context derived from at least one transform block neighboring the block.

14. The apparatus of claim 13, wherein to entropy encode the symbol using CABAC comprises to:
derive three bits representing the context from at least one transform block neighboring the block; and
entropy encode the symbol using a combination of the three bits.

15. The apparatus of claim 14, wherein:
the block comprises a first transform block that belongs to a prediction block; and
a value of a bit of the three bits for a position of a neighboring transform block comprises:
0, when the neighboring transform block is not present at the position;
1, when the neighboring transform block is present, belongs to the prediction block, and only its DC coefficient has a non-zero value; and
0, when the neighboring transform block is present and at least one of the neighboring transform block does not belong to the prediction block or more than one of transform coefficients of the neighboring transform block has a non-zero value.

16. The apparatus of claim 10, wherein the processor is configured to:
determine whether the block includes transform coefficients only having zero values; and
encode a zero-coefficient symbol indicating whether the block includes at least one transform coefficient having a non-zero value, wherein:
to determine whether only the DC transform coefficient has the non-zero value and to encode the symbol only occurs responsive to a determination that the block includes at least one transform coefficient having a non-zero value.

17. (canceled)
